(19) United States
(12) Patent Application Publication
(10) Pub. No.: US 2002/0173353 A1
(43) Pub. Date: Nov. 21, 2002

(54) Gaming Machines

(76) Inventor: Arthur Edward Thomas, Glamorgan (GB)

Correspondence Address: HOGAN & HARTSON LLP, ONE TABOR CENTER, SUITE 1500, 1200 SEVENTEENTH ST, DENVER, CO, 80202, US

(21) Appl. No.: 10/152,529

(22) Filed: May 21, 2002

(30) Foreign Application Priority Data
May 21, 2001 (EP) 01304456.5

(51) Int. Cl. A63F 13/00

(52) U.S. Cl. 463/17

(57) ABSTRACT

A gaming machine has a set of symbol-bearing reels, preferably simulated, which display multiple combinations of symbols. If, following a reel spinning operation, one or more of these combinations is a predetermined winning combination, and the location of the winning combination has been previously selected by the player, the player is granted an award. There is a further symbol-bearing reel and the player is given the opportunity to select a symbol on that further reel. If, following a reel spinning operation, the selected symbol is aligned with a winning combination of symbols of the other reels, the player is granted an award. At least two games can be played using the further reel, the games having different restrictions on the amounts permitted to be staked. Separate money-receiving means are provided for placing the stakes on the respective games. The machine may have multiple terminals each operable by a respective player independently of the operations carried out by the other players.

### BACKGROUND OF THE INVENTION

1. Field of the Invention

This invention relates to gaming machines, which term is used herein to refer to any device by means of which a user can play a game and, depending upon the results of the game, obtain a credit value. The machine preferably pays out cash and/or tokens in an amount corresponding to the credit value.

2. Description of the Prior Art

In the art, those machines which pay out only cash are sometimes referred to as “gaming machines”. Herein, however, the term gaming machine is used in a generic sense, as the invention is applicable also to other types of machines such as those known as “amusement with prize” machines, which pay out both cash and tokens. The invention is particularly applicable to machines sometimes known as “fruit machines”, which incorporate symbol-carrying reels which are spun during the playing of a game so as to alter in a random or pseudo-random manner the combination of symbols which can be viewed by the user. These reels may be simulated and displayed using a visual display unit, such as an LCD screen or a cathode ray tube. The circuitry of such machines and the basic modes of operation are well known; an example is described in GB-A-2 117 155, the contents of which are incorporated herein by reference.

It would be desirable to provide a machine which provides additional facilities which enhance the attractiveness of the machine to potential players. It would be particularly desirable to provide additional gambling features.

### SUMMARY OF THE INVENTION

Aspects of the present invention are set out in the accompanying claims.

According to a further aspect of the invention, a gaming machine has a set of first reels which can be spun to change combinations of symbols which are displayed. Preferably, multiple symbols from each reel are displayed simultaneously, these being arranged in multiple combinations each comprising a symbol from each of the respective reels. Any of the combinations which corresponds to one of a number of predetermined symbol combinations constitutes a nominal (or actual) win. There is a further reel, and the machine is arranged to provide the player with an opportunity to select one (or preferably an opportunity to select more than one) of the symbols on the further reel. This further reel can also be spun. If at the end of this spinning operation a selected symbol is aligned with a winning combination on the other reels, the player is awarded a prize.

In contrast to conventional fruit machines, such an arrangement provides enhanced attractiveness and variety because (a) it allows a user to select a particular symbol or particular symbols to bet upon, (b) the position at which the selected symbol must appear in order to provide a win is variable, and (c) the number of positions at which a win is awarded is also variable, the variations in the number and locations of the winning positions being determined by the set of first reels.

The set of first reels can also be used in a substantially standard way by giving awards if winning combinations appear, these awards preferably being conditional upon the player having previously made a bet associated with the location at which the winning combination appears.

As will become clearer in the following description of a preferred embodiment, a machine according to the present invention is likely to display a large number of symbols and other features, and is also likely to provide numerous options which the player can select. For this reason, the machine preferably incorporates a display unit and at least some and preferably all of the reels are simulated reels displayed on the unit. This same display unit can also be used to offer the options for selection by the player, for example by having different display regions associated with the respective options, and allowing the user to indicate selected display regions using a touch screen or a cursor.

One advantage of using a simulated reel for the further reel mentioned above is that it permits the symbol sequence on the reel to be altered, for example so that the reel can be used in other, supplementary games.

According to another aspect of the invention, a gaming machine has a common display means (such as a reel) for producing a changeable display, and permits a player to play at least two games both using this same display means. The different games have different restrictions (possibly imposed by law) in respect of the amounts permitted to be staked on the respective games. The machine has two separate stake-receiving means, such as slots for permitting insertion of coins, for the respective games. This allows the player more readily to organise the placing of stakes on the respective games.

According to a still further aspect of the invention, a gaming machine comprises a plurality of interlinked terminals each of which can be operated by a respective player, whereby the players can participate in a reel spinning game which is common to all the players, and which can result in the awarding of prizes in dependence upon selections made independently by the respective players. This permits the player to compete against each other on the same game, so that their relative performances are not influenced by operating different games as in conventional arrangements. Furthermore, the fact that each player can make his selections independently of the other players allows a free choice in the way in which the players make their selection so that some players may make the same selection and others different selections, thus providing them with equal opportunities.

The individual terminals are provided to allow the different players to make their individual selections. The terminals may also be provided with display means for displaying the reels. Alternatively, or additionally, there is a common display means which is visible to a number of the players; this may for example be a display projected on to a large screen. This type of arrangement is particularly attractive in situations where group activities take place, for example arcades, bingo halls, casinos and single sites. Additionally, or alternatively, the terminals may be remote from each other, and interconnected via, for example, the internet.

This aspect of the invention is particularly useful when combined with the first-mentioned aspect described above, whereby the different players are able to make independent selections of symbols from the further reel, thus influencing their respective opportunities to be awarded prizes.

### BRIEF DESCRIPTION OF THE DRAWINGS

Arrangements embodying the invention will now be described by way of example with reference to the accompanying drawings, in which:

FIG. 1 schematically shows a stand-alone gaming machine in accordance with the invention;

FIG. 2 illustrates by way of example a display provided by the machine of FIG. 1;

FIGS. 3 and 4 respectively illustrate displays of modified embodiments of the invention; and

FIG. 5 schematically shows a multi-terminal gaming machine in accordance with the invention.

### DETAILED DESCRIPTION OF THE PREFERRED EMBODIMENTS

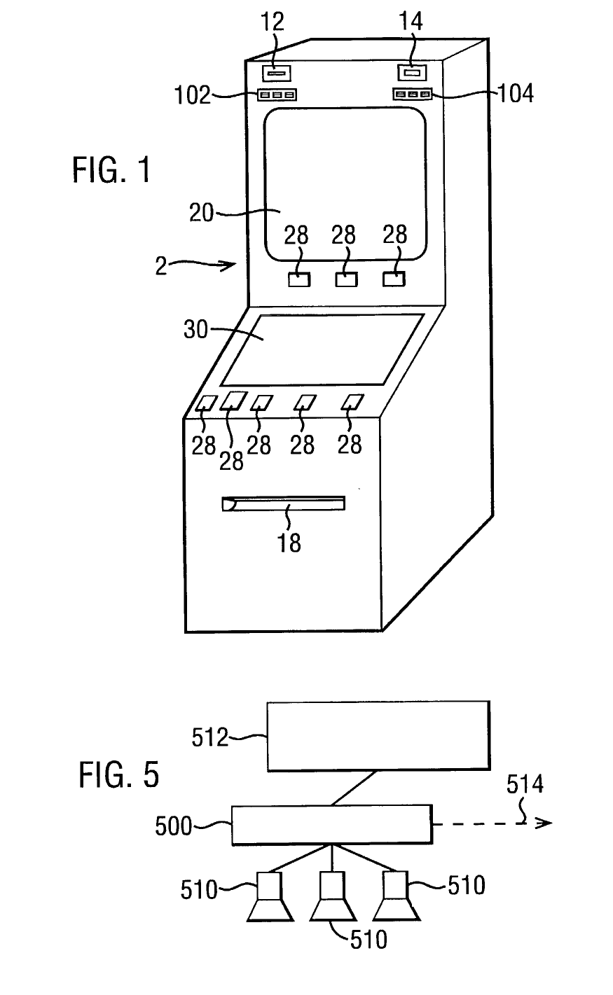

Referring to FIG. 1, a gaming machine 2 is arranged to receive coins and tokens through slots 12 and 14, and to deliver coins or tokens to a tray 18 if a player wins a prize. Provision may be made for payment or prizes to be in other forms than cash or tokens, for example by use of a credit or debit card.

The machine 2 also has two video screens, 20, 30 which in this embodiment are both screens of cathode ray tube monitors. As will be described, these provide displays of various game features, including simulated symbol-carrying reels. Other types of electrically alterable display screens can be used, such as LCD or projection displays, and indeed at least some of the game features could be embodied in electromechanical arrangements.

The machine 2 also has various push-buttons 28 allowing the player to initiate various operations and make various selections in order to play a game. FIG. 1 shows these as physical push-buttons operating electrical switches, but some or all could alternatively be replaced by display areas of the screens 20, 30, the player being able to provide instructions to the machine by selecting these display areas, which can be achieved either by movement of a cursor or, preferably, by physically touching the display areas, for which purpose the screens 20, 30 are preferably touch screens.

Gaming machines having touch-responsive video screens by means of which players can play games, such as games involving simulated symbol-carrying reels, are very well known in the art, and anyone skilled in the art will be easily capable of designing and constructing the necessary hardware. Furthermore, the software techniques required to produce the necessary displays and to operate the games are well known to those skilled in the art, and the necessary modifications required in order to provide the displays and games described below will be clear. Also, other means may be provided for player operation, such as voice actuation.

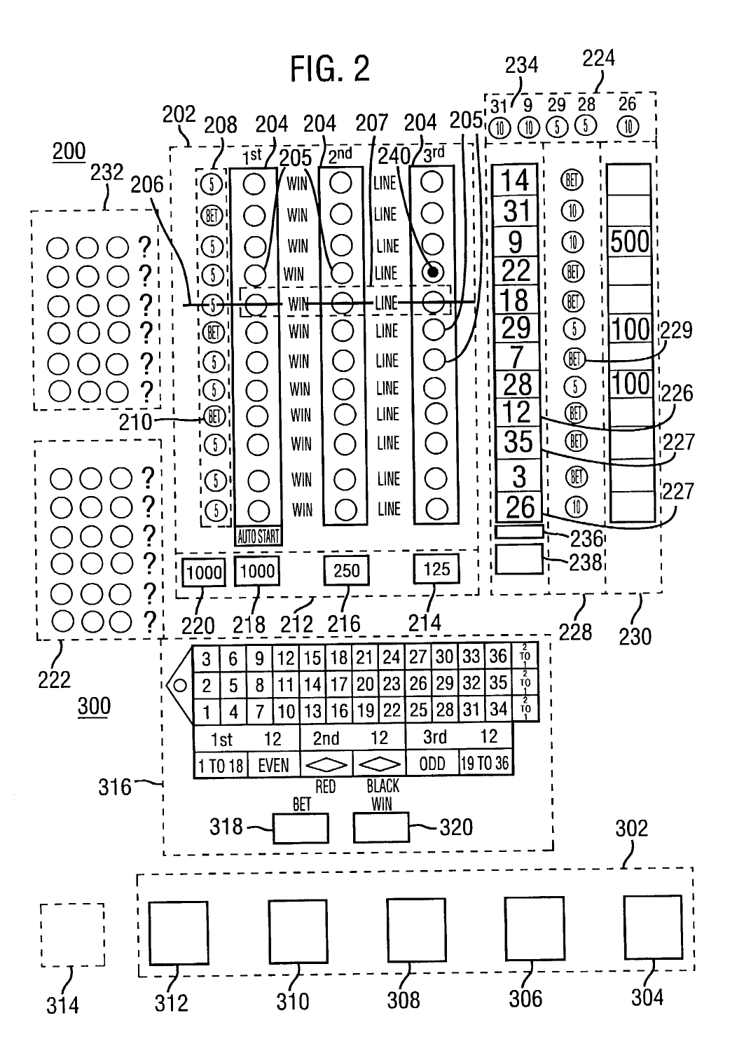

Referring to FIG. 2, this schematically illustrates an example of the displays that can be provided by the screens 20, 30. This includes two main display areas 200, 300, which illustrate the displays provided by the screens 20, 30 respectively. For the purposes of FIG. 2, it is assumed that the physical switches 28 of FIG. 1 are replaced by display screen areas.

The main area 300 includes a game selection area 302 in which are disposed simulated push-buttons 304, 306, 308, 310 and 312. As will be described, these allow for selection of different types of main and supplementary games.

The main area 200 includes a first reel area 202 which displays portions of three main, or “first” reels 204. Each portion is large enough to display 12 successive symbols, such as those shown at 205. Preferably, each reel has more than this number of symbol positions (known as “stops”) in total (for example there may be 256 stops for each simulated reel). The reel portions are arranged such that the 12 displayed symbols on each reel are aligned with the respective symbols on the other reels, thus providing 12 horizontal “win lines”, one of which is shown at 206. Each win line 206 forms a location at which is displayed a respective combination of symbols 205, such as the combination shown at 207.

The main reel area 202 also includes a win line selection area 208 containing win line selection buttons such as that shown at 210 by means of which the player can select one or more individual win lines.

The main area 200 further includes a credit/win display area 212. This includes four numerical displays, 214, 216, 218 and 220 showing, respectively, the total amount bet on the current game, the amount of credit to which the player is entitled, the amount won by the player and the amount of winnings which has been paid out to the player (which may be equal to the amount won by the player unless there is insufficient stored cash to meet this).

The main area 200 also includes a normal award display area 222 which displays a plurality of (in this case six) predetermined combinations of winning symbols which may give rise to awards if those combinations appear in the main reel area 202. The normal award area 222 also indicates, for each predetermined combination, a value which is used to work out the amount which may be won if that combination appears.

There will now be described how a player may play a main reel game using the gaming machine 2. This constitutes a first type of game.

The player first selects this game by operating the button 304. The player may then select one or more of the win lines 206 by operating the associated button or buttons 210. Each time a button is pressed, a certain amount of credit is deemed to be bet on the associated win line, so the amount bet can be multiplied by successively pressing the same button 210. The total amount bet display 214 and the credit display 216 are updated accordingly. Each button 210 can also display the amount bet on the associated win line.

The reels 204 are then spun. This could be started automatically after a predetermined interval, or the spinning could be started in response operation of a start button such as that shown at 314 in the main area 300.

The reels then stop spinning. If one of the winning combinations shown in the award area 222 is present on a win line 206 for which the player has placed a bet, then the machine 2 awards a prize. This is a value which is proportional to the amount bet multiplied by the award shown in the panel 222 and associated with the winning combination that appears on the line. The amount won is shown in the display area 218. Preferably, the amount is automatically paid out, and the amount paid is shown in the display 220. If the player has bet on more than one of the lines 206, and winning combinations appear on more than one of the selected lines, then the total amount won is the sum of the awards for each individual line.

The main display area 200 also includes a further reel area 224. This shows a portion of a further reel 226, this portion also revealing a plurality, for example 12, of the symbols 227 carried by this reel. Each of the revealed symbols is aligned with a respective one of the win lines 206 in the main reel area 202. The symbols carried by the further reel 226 need not have any particular relationship with the symbols carried by the reels 204. In the embodiment shown, the symbols carried by the reel 226 are numbers, (but alternatively other types of symbols, such as playing cards, could be used.) Again, preferably, the reel 226 carries more symbols than are visible in the further reel area 224. There may for example be 24 or 36 different symbols on the reel 226.

The further reel area 224 also includes a further reel bet area 228 containing a plurality of selection buttons, such as that shown at 229, each associated with a respective one of the displayed symbols on the reel 226. There is also a further reel win area 230 comprising a column of numerical displays each associated with a respective one of the displayed symbols on the reel 226.

The main display area 200 includes a further reel award area 232. This is similar to the normal award area 222, and may indeed display the same predetermined combinations of symbols, but the displayed awards associated with these combinations may be different from the awards displayed in the area 222. (In an alternative embodiment, the combinations shown in the areas 222, 232 are different, and/or there are different numbers of combinations in the respective areas.)

In order to play a game involving the further reel 226 (which constitutes a second type of game), the player operates the push-button 306 in the main area 300. The player can then select one or more individual symbols 227 shown on the reel 226 by operating the associated selection buttons 229. The operation is similar to that of the selection buttons 210 in that the number of times the button is pressed will determine the total amount bet on the associated symbol, and the button 229 displays this amount.

The further reel area 224 includes a monitor area 234 which contains numerical displays showing (a) the symbols selected and (b) the amount bet on each of these selected symbols.

The reel 226 is then spun. This could take place at the same time as the spinning of the reels 204, or in an alternative embodiment could be separately instructed by operating a button 236. After the reel 226 has stopped spinning, a player is awarded a prize if a number that he has selected is aligned with a win line 206 which contains a predetermined symbol combination shown in the further reel awards area 232. The win is awarded irrespective of whether the player has bet on that win line using one of the push-buttons 210. The amount awarded is proportional to the amount bet multiplied by the award shown in the area 232 and associated with the combination appearing on the win line 206 aligned with the selected number. Because multiple symbols on the reel 226 can be selected, the player may win multiple awards in which case the total amount is the sum of those awards. The amount won for each selected symbol can be shown by the associated display in the further reel win area 230.

During the course of this game, the amounts shown in the credit/win area 212 are updated according to the amounts won and bet.

Before the spinning of the reel 226, the player may find that a symbol that he wishes to select is not visible. Preferably, therefore, a button 238 is provided which allows the player to step-wise rotate the reel 226 so as to bring into view the symbol which he wishes to select.

The further reel game described above is particularly attractive because (a) it allows the player to choose the symbols that he wishes to bet upon, (b) it allows the player to choose multiple symbols, (c) it allows for the possibility of a variable number of wins, (d) the locations of the winning positions are variable and (e) the use of a plurality of reels 204 to determine the number and positions of the winning lines enhances the interest in the game.

In this embodiment, a player can achieve a win using the second type of game if a selected symbol 227 on the further reel 226 is aligned with a first reel combination 207 which matches any one of the predetermined combinations shown in the further reel awards area 232. In an alternative embodiment, means are provided for a player to select a specific one (or more than one) of the predetermined combinations shown in the awards area 232 before the reel 226 is spun. In this alternative embodiment, the player is awarded a win only if, following the spinning of the reel 226, his selected symbol 227 is aligned with the combination of first-reel symbols which he has previously selected.

It is to be noted that the symbol combinations shown in the awards areas do not necessarily require specific symbols from every one of the first reels 204. For example, a winning combination could be formed by a pair of matching symbols on the left reel 204 and the centre reel 204, irrespective of the aligned symbol on the right reel 204.

Preferably, the first and second types of game can be played simultaneously, so that the player is able to make selections using the push-buttons 210 and 229 before the reels are spun, and is potentially able to accumulate awards from both games at the same time. This could be achieved by the player operating both the push-buttons 304, 306 before a game starts. However, alternatively, the arrangement may be such that, whenever a game is played, all four reels spin during the course of the game, and the player is able to play the first type of game by operating one or more of the buttons 210 and the second type of game by operating one or more of the buttons 229. In this case, the two selection buttons 304, 306 could be replaced by a single button, or indeed omitted entirely.

It is not necessary for all the four reels 204, 226 to be spun simultaneously. However, it is desirable to require that the operation of push-buttons 210 take place before the spinning of the reels 204, and the operation of the push-buttons 229 to take place before the spinning of at least the reel 226, and preferably before the reel 226 and at least some if not all the reels 204.

The main display area 300 also includes a supplementary game area 316. This allows for the playing of a third type of game, this game also being associated with the further reel 226. Different variations of this third game are provided. Assuming that the player operates the button 308, the third game is a form of roulette and the display area 316 is caused to show a betting selection area similar to that of a standard roulette table as shown in FIG. 2. Using the touch screen 30, a player can make bets by selecting appropriate regions within the area 316. The total amount bet is shown by a numerical display 318.

In order to play this game, the symbols carried by the reel 226 should be appropriate for a roulette game. It may be that the second type of game described above also uses such an arrangement of symbols. However, this is not essential. Instead, upon selecting the roulette game by operating the push-button 308, the machine may be arranged so as to change the symbols carried by the reel 226 so as to make them suitable for a roulette game. This may for example involve increasing or decreasing the number of symbols, or possibly adding colours to the symbols.

The roulette game is then played by spinning the reel 226, for example by operating the button 236. After the reel has halted, one of the displayed symbols is selected. In the illustrated embodiment, this is achieved using an indicator 240, which may simulate a roulette ball, and which can be arranged to travel upwardly or downwardly before coming to a halt to select one of the displayed symbols on the reel 226. The machine then calculates the amount, if any, won by the player and displays this amount in a display area 320.

By way of example, another variation of the third game can be obtained by operating the push-button 310. In this case, the display area 316 will display instead a simulated bingo card on which bets can be placed. The symbols will correspond to those on the reel 226, if necessary after altering those on the reel. Following spinning of the reel 226, multiple ones of the displayed symbols may be selected, and if these selected symbols form a predetermined pattern on the simulated bingo card, an award is provided. The selection of multiple symbols from the reel 226 may be achieved in the same way as in the second game described above, i.e. the symbol is selected if it is aligned with a win line 206 containing a predetermined combination of symbols from the reels 204.

If selection of symbols from the further reel 226 is performed as in the second type of game, (i.e. in dependence on winning combinations appearing on the reels 204) it may be that the chances of winning the bingo game are low. To compensate for such circumstances, the machine may be arranged so that the third type of game involves accumulating the symbols selected following a plurality of spins of the further reel, so the total number of selected symbols is increased.

Other variations may be provided. For example by pressing the button 312, the display area 316 may be arranged to provide a Keno-type display allowing an individual to select numbers corresponding to those carried by the reel 226 (again, if necessary, altering the symbols carried by the reel). Wins are awarded depending upon whether a symbol selected by the player using the display region 316 matches the symbols selected on the reel 226 after it is spun.

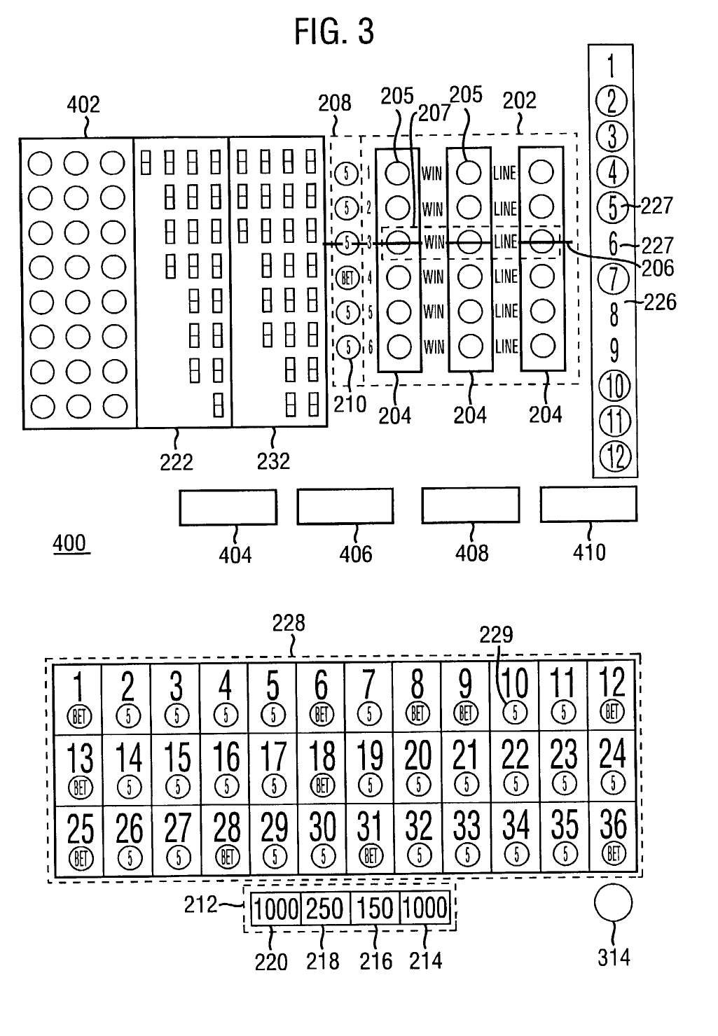

FIG. 3 shows the display of a modified embodiment of the invention. Features corresponding to those of FIG. 2 have like reference numbers. The following description will relate primarily to those features which differ from the embodiment of FIG. 2.

The main display areas 200, 300 of FIG. 2 may be replaced by a single display area 400, if desired. There is a single reel award area 402, including respective columns 222, 232, which display awards for the first and second types of games, corresponding to the award areas 222, 232 of FIG. 2.

As shown in FIG. 3, the main reel area 202 shows six symbols of each of the main reels 204, thereby providing six win lines 206. However, a feature of the present embodiment is that the number of displayed win lines is variable. A plurality of pushbuttons, 404, 406, 408 and 410, is provided. Each pushbutton, when operated, causes a different number of reel symbols, and thus win lines, to be displayed, in exchange for differing amounts of credit. For example, operating the pushbutton 404 causes three win lines (i.e. three symbols from each of the reels 204) to be displayed in exchange for a credit value of x. Operating pushbutton 406 causes the display of six win lines in exchange for a credit value of 2x. Operating pushbutton 408 causes nine win lines to be displayed in return for a credit value of 3x and operating pushbutton 410 causes twelve win lines to be displayed in return for a credit value of 4x. (Instead of providing pushbuttons, the number of win lines could be dependent upon the number of coins deposited in the machine.)

It will therefore be appreciated that the user has the option of increasing the number of win lines, in return for additional payment, which thus increases the likelihood of achieving a win using the second type of game mentioned above, involving the further reel 226.

Another feature of this embodiment is that the further reel bet area 228 is now separate from the further reel 226 and comprises an array showing all the symbols which are carried by the reel 226, each symbol having associated therewith a respective selection button 229 so that an individual bet may be placed on that symbol. This provides an easier way to select symbols of the further reel 226, and avoids the need for the monitor area 234 of FIG. 2. This also avoids the need for the button 238 which provides stepwise rotation of the reel 226 to enable symbol selection. Additional pushbuttons may be provided to enable simultaneous selection of multiple symbols; for example, buttons may be provided for selecting rows and/or columns of the symbols in the array displayed in the further reel bet area 228.

Preferably, any symbols on the reel 226 which have been selected using the bet area 228 are indicated on the reel; in the illustrated embodiment, this is achieved by placing a circle around the selected number.

In operation, after the player has selected how many win lines he wishes to be displayed, for example using an appropriate one of pushbuttons 404, 406, 408 and 410, the machine operates in the same way as the embodiment of FIG. 2 operates in order to play the first and second type of games. The player can operate selection buttons 210 in order to bet on individual win lines, and can select individual symbols on the reel 226 which, following spinning of the reels, will result in a win for each selected symbol which is aligned with a winning combination on the reels 204.

If desired, the machine may be arranged such that certain bets are placed on individual win lines in dependence upon how many win lines are selected. For example, if pushbutton 404 is operated to select three win lines, a bet corresponding to a predetermined credit may be automatically placed on the central win line. Similarly, bets may be automatically placed on two win lines if six are caused to be displayed by operation of pushbutton 406, three bets are placed on respective win lines if nine win lines are selected for display using pushbutton 408 and four bets are placed on respective win lines if twelve win lines are selected for display using pushbutton 410.

In an alternative arrangement, the number of potential win lines, i.e. the number of symbols displayed by each of the first reels 204, is fixed. Instead, the number of displayed symbols 227 of the further reel 226 can be altered in order to change the likelihood of achieving a win using the second type of game. Thus, for example, the first reel 204 may display 12 potential win lines, and the further reel 226 may display, selectively, either 3, 6, 9 or 12 symbols. In a further alternative embodiment, the further reel 226 displays the same number of symbols as each of the first reels 204, and this number is alterable.

FIG. 4 shows a further embodiment which uses some of the features in FIG. 2 and FIG. 3 embodiments. Again, like reference numbers represent like features.

The FIG. 4 embodiment uses a bet area 228 containing pushbuttons/displays 229 aligned with respective symbols on the reel 226 placing bets on those symbols as in the embodiment of FIG. 2. However, whenever the reel 226 rotates, the bet status as shown on the selection buttons 229 alters in synchronism; that is, the selection buttons 229 also rotate with the reel 226. Accordingly the amount bet on each of the symbols on the reel 226 can be determined from the associated region within the bet area 228, thus avoiding the need for the separate monitor area 234 of FIG. 2. The same effect can be achieved if the selection buttons 229 are carried by the reel 226.

The machine may be provided with a pushbutton 238 to instruct stepwise rotation of the reel 226 to enable selection of symbols which are not currently visible. Alternatively, the reel 226 may be arranged to rotate continuously or automatically at timed intervals for this purpose. Instead of stepwise rotation, the reel 226 could be repositioned in a single operation to replace all the displayed symbols by symbols which were previously not visible.

The embodiment of FIG. 4 can be used to play an auxiliary game, such as roulette, similar to the embodiment of FIG. 2. In this case, the display area 316 used for the auxiliary game contains simulated chips associated with different values in a region 412. The player can place a bet by touching the chips and also touching individual regions within the area 316 associated with symbols on which he wishes to place the bet.

The machine is provided with an auxiliary display reel 414 carrying an indicator 240. This auxiliary reel 414 can be spun in a different direction and/or at a different speed from the further reel 226. Preferably, the whole of the reel 414 is displayed.

This embodiment operates as follows. The player first selects how many win lines he wishes to use, by means of pushbutton 404, 406, 408 or 410. He can then place bets on individual win lines using the pushbuttons 210 in order to play the first type of game. He can also use the pushbuttons 229 to select individual symbols on the reel 226 in order to play the second type of game. If he wishes, he can additionally play the auxiliary game by operating the pushbutton 308, and placing bets using the display region 316. As in the embodiment of FIG. 2, the symbols on the further reel 226 match the symbols which can be selected in region 316 for the auxiliary game. Any symbols which are bet upon in the auxiliary game using the display region 316 are indicated on the further reel 226 (in the illustrated embodiment by a tick mark at the side of the symbol). The reels are then spun by operating the pushbutton 314.

After the reel spinning operation, a first set of awards calculated from column 222 is provided if any winning combination is associated with a win line on which a bet has been placed using a pushbutton 210. A second set of awards is provided, based on the values in column 232, if a symbol on reel 226 which has been selected using a pushbutton 229 is aligned with a winning combination on the reels 204. After the reel spinning operation, the symbol on the reel 226 which is aligned with the indicator 240 constitutes the winning symbol for the auxiliary game. A further award is provided if this symbol has previously been selected using the display area 316.

In the above embodiments, it may be desirable in some cases to provide an additional means whereby, after the further reel 226 has been spun, the player has the option of re-spinning the reel, or moving it in a step-wise manner (using a so-called “nudge” facility) in order to have additional chances for achieving a win.

In the foregoing, it is assumed that the player has a single credit balance which is increased by, for example, insertion of coins and tokens through the slots 12 and 14; the slot 12 may be arranged to receive coins and the slot 14 to receive tokens. However, in a preferred arrangement, the player has two credit balances, one of which is displayed on an indicator 102 and is increased by feeding coins (and possibly tokens) through slot 12, and the other of which is displayed by indicator 104 and is increased by feeding coins (and possibly tokens) through slot 14. The player can use the credit displayed on indicator 102 for placing bets on only the first and second types of games described above, and the amount displayed on the indicator 104 for placing bets on only the third type of game described above. The third type of game, which for example may be a roulette game as described above, may have different restrictions from the other games. For example, the law may permit higher stakes to be placed on the third game than on the other two types of games. By providing two credit balances, preferably indicating credit obtained by a respective stake-receiving means, the player and the machine can readily distinguished between amounts intended for betting upon the respective games. Of course, other stake-receiving means such as credit card readers can be provided as well as or instead of the coin-receiving slots 12 and 14.

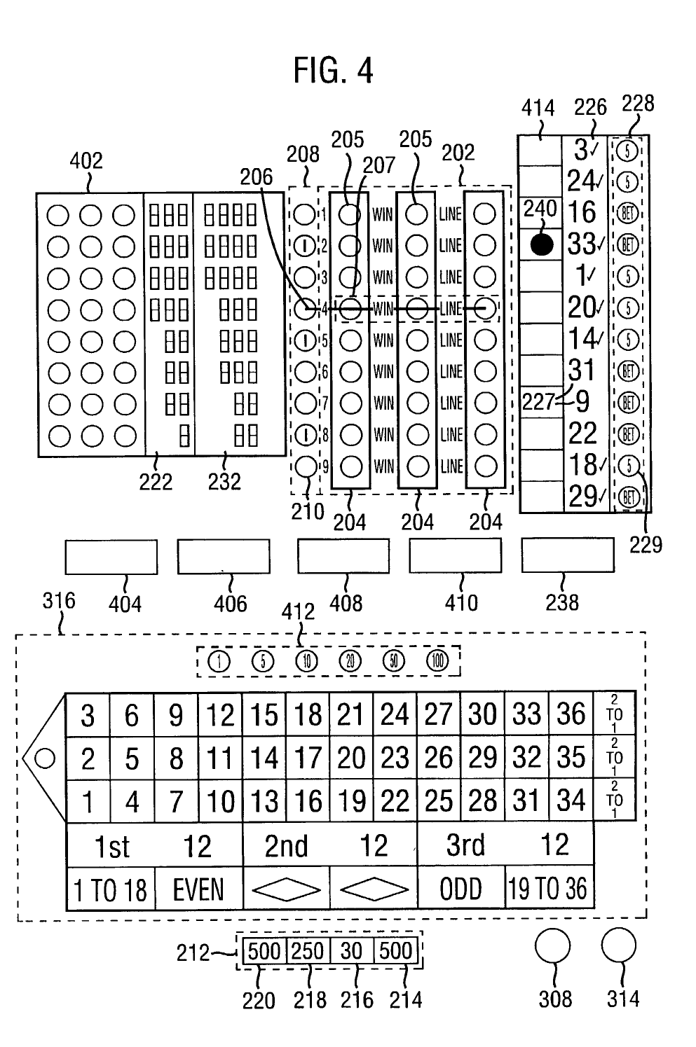

Referring to FIG. 5, any of the embodiments described above could be implemented as shown here. There is a central controller 500 containing the necessary logic for operating the games described above. This is linked to multiple terminals 510 which allow respective players to make selections for use in playing the game. The terminals 510 may also be provided with display means for displaying the reels 204 and 226. Alternatively, or additionally, there may be one or more main displays 512 each visible to multiple players for showing these reels.

The controller 500 may also be linked, as indicated at 514, to remote terminals, for example via telephone lines and/or the internet.

The players' games all involve a common set of reels, and each player has the ability to make selections which are completely independent of the selections made by other players, so that his selections may be the same or different from the other players. This enhances the competitive aspects of the game. This is particularly attractive in playing the second type of game mentioned above, involving the selection of symbols on the further reel 226.

Preferably, the games are started by spinning the reels at timed intervals. Alternatively, the games start after all the players have indicated, for example by pressing a button, that they have made their bets, although in the latter cases preferably a limit to the amount of time permitted for this to occur.

Instead of having a central controller 500 for controlling the reels, there could be an independently-operable gaming machine which can be played by itself, or in another mode can be linked to other independently-playable machines, in a master/slave arrangement, such that when linked together the slave machines are all caused to operate their reels in synchronism with those of the main machine.

In the arrangements described above, it is preferable for each of the reels 204 to have a predetermined set of symbols in a fixed sequence, as on a conventional electromechanical reel, so as to enhance player confidence. It would, however, be possible for the symbol sequence to be varied; in other words, the displayed symbols could be rearranged in a random manner instead of having a simulation of a reel spinning operation.

The same applies to the reel 226, although as indicated above it may be desirable for the machine to be able to switch between different predetermined symbol sequences for the purpose of the supplementary games.

Any of the features described in relation to any of the above embodiments may also be incorporated in the other embodiments. Many variations, e.g. in the number of reels provided, are possible. There could be more than one further reel 226. Although the win lines 206 are straight and horizontal in the disclosed embodiments, they could be of any other configuration or combination of configurations, so long as the symbols associated with each win line are identifiable, e.g. by using appropriate indicia.

1. A gaming machine comprising:
a plurality of symbol-carrying first reels which display a plurality of combinations of symbols, these combinations being alterable by spinning the reels;
a further symbol-carrying reel operable to display multiple symbols each associated with a respective one of the displayed combinations of first reel symbols;
means permitting a player to select a symbol of the further reel; and
means to provide, following the spinning of the reels, a first award in dependence on whether one of said first reel symbol combinations is a predetermined symbol combination and a second award in dependence on whether the selected symbol is associated with said predetermined symbol combination.

2. A machine as claimed in claim 1, wherein the machine is arranged to provide said awards in dependence on whether the first reel symbol combination associated with the selected further reel symbol is any one of a number of different predetermined symbol combinations.

3. A gaming machine comprising a plurality of symbol-carrying first reels which display a plurality of combinations of symbols, these combinations being alterable by spinning the reels, the machine including a further symbol-carrying reel operable to display multiple symbols each associated with a respective one of the displayed combinations of first reel symbols, the machine further comprising means permitting a player to select a plurality of different symbols of the further reel and means to provide, following the playing of a game, an award in dependence on whether a first reel symbol combination associated with any one of the selected symbols is a predetermined symbol combination.

4. A machine as claimed in claim 3, including means whereby the player can alter the number of displayed combinations of first reel symbols associated with further reel symbols, thereby influencing the chances of a selected further reel symbol being associated with a predetermined first reel symbol combination.

5. A machine as claimed in claim 3, including means whereby the player can alter the number of displayed further reel symbols, thereby influencing the chances of a selected further reel symbol being associated with a predetermined first reel symbol combination.

6. A machine as claimed in claim 3, wherein the machine is arranged such that selection of each symbol requires payment of a respective stake.

7. A machine as claimed in claim 3, including means associated and movable with each selected further-reel symbol for indicating that the symbol has been selected.

8. A gaming machine comprising:
a plurality of symbol-carrying first reels which display a plurality of combinations of symbols at respective locations, these combinations being alterable by spinning the reels;
a further symbol-carrying reel operable to display multiple symbols each associated with a respective one of the displayed combinations of first reel symbols;
means permitting a player to select (a) at least one symbol of the further reel and (b) at least one location; and
means to provide, following the playing of a game, an award in dependence on whether the first reel symbol combination at a selected location is a predetermined symbol combination and is associated with a selected symbol

9. A machine as claimed in claim 8, wherein the machine is arranged so that the same combination of first reel symbols can give rise to a first award if that combination appears in a selected location and a second award if a selected further reel symbol is associated with that combination.

10. A machine as claimed in claim 9, wherein the machine is operable to provide both the first and second awards in a single game.

11. A machine as claimed in claim 1, wherein the further reel is a simulated reel, and wherein the machine is operable to alter the sequence of symbols carried by the reel for the purpose of allowing a player to play a different game using said further reel.

12. A machine as claimed in claim 1, wherein the machine has at least two stake-receiving means by means of which a player may place stakes on respective games the results of which are dependent upon the operation of the further symbol-carrying reel.

13. A machine as claimed in claim 1, the machine including a plurality of terminals each of which can be operated by a respective player, thereby permitting the players to make independent selections of the symbols of the further reel.

14. A gaming machine as claimed in claim 13, including at least one single display, for displaying the first reels and the further reel, which is visible to a plurality of players.

15. A gaming machine comprising a plurality of terminals each of which can be operated by a respective player so that the players can play a game involving a common set of symbol-bearing reels, the players being permitted to make selection operations independent of the operations made by the other players, such operations influencing the possibility of awards being granted to the players and the amounts of such awards.

16. A machine as claimed in claim 15, including at least one single display, for displaying said set of symbol-bearing reels, which is visible to a plurality of said players.

17. A gaming machine having a common display means for providing a changeable display, the machine being arranged to allow a player to play at least two games, the results of both games being dependent on the display produced by the common display means at the end of the games, wherein the machine is arranged to provide different restrictions on the amount permitted to be staked on the respective games, and has separate stake-receiving means for the respective games.
